(19) United States
(12) Patent Application Publication
(10) Pub. No.: US 2015/0217553 A1
(43) Pub. Date: Aug. 6, 2015

(54) Print-on-demand method for creating the top layer of a quilt or the like

(71) Applicant: Tammie Larae Bowser, South Pasadena, CA (US)

(72) Inventor: Tammie Larae Bowser, South Pasadena, CA (US)

(21) Appl. No.: 14/140,474

(22) Filed: Dec. 25, 2013

(51) Int. Cl. B32B 37/14

(52) U.S. Cl. CPC B32B 37/14; B32B 2255/00

(57) ABSTRACT

A print-on-demand method for creating the top layer of a quilt includes utilizing a computer, a computer software program to create a desired design which is to be printed directly onto multiple fabric sheets (2). The sheets (2) are formulated (4) to preserve the printed design (16) and have a rigid liner (6) attached to facilitate printing by use of a standard consumer desktop printer. The sheets (2) are strategically positioned, attached and trimmed to form the top layer of the desired quilt (20). The method minimizes the waste of fabric material (8) by using only what is necessary. A pre-fabricated material and an alternate self-fabricated material method is described.

### CROSS REFERENCE TO RELATED APPLICATION:

This application is entitled to the benefit of Provisional Patent Application No. 61/848,245, filing date: Dec. 27, 2012.

### FIELD OF THE INVENTION

This invention relates to quilt making, specifically using computer software to enable more efficient and versatile quilt making by consumers.

### BACKGROUND OF THE INVENTION

Quilting is a sewing process which joins multiple layers of material (typically fabric) together to make what is traditionally called a quilt. The process usually involves strategically joining a top layer of fabric, a middle layer of batting or filler and a bottom layer of backing material. The top layer which is the artistic or creative layer is typically formed with joining and attaching multiple pieces of fabric (patches) having various patterns, colors and/or textures (or combination thereof) to form a desired pattern, design or image for viewing.

Quilting traditionally involves six basic steps: 1) selecting material for each layer, 2) measuring fabrics to cut them to the desired patch size for the top layer, 3) joining the top layer pieces together by sewing (manual, automated or combination thereof), 8) strategically layering and attaching batting for middle layer, 5) sewing or stitching the layers together, 6) trimming the materials as needed.

Because of how intricate the above steps are (particularly for the top layer), the more varied and complex the desired finished quilt's pattern, design or texture, the more time consuming and difficult it is to create. In addition, traditional methods result in a significant amount of wasted fabric/material since fabrics/materials are usually only available in certain sizes and quantities. As such, a method which would simplify and make the quilting process more efficient and versatile; regardless of how intricate the quilt design, and one which can significantly minimize the amount of fabric/material that is wasted and one which would be compatible with standard desktop consumer hardware (e.g. computer and printer) would be beneficial for consumers to allow them to make quilts easier and more conveniently regardless of how complex.

### SUMMARY OF THE INVENTION

The invention comprises a print-on-demand method for creating the top layer of a quilt, which enables consumers to efficiently make quilts; from simple to complex images as well as minimize wasted fabric by allowing consumers to create (print) only as much fabric material as is needed. The invention is designed to work with standard desktop consumer computers and printers. A preferred pre-fabricated material method and an alternate self-fabricated material method is described.

### DRAWINGS—FIGURES

In the drawings, closely related figures have the same number but different alphabetic suffixes.

FIG. 1 shows a graphic diagram of the preferred and alternate method (example).

FIG. 2 shows an elevational view of a printable fabric sheet (example).

FIG. 3 shows an elevational view of a finished guilt having multiple fabric sheets (example).

FIG. 4 shows an enlarged cross sectional view of a fabric sheet with liner (example).

### DRAWINGS—REFERENCE NUMERALS

2 Fabric Sheet w/adhesive adhesive liner

4 Preservation formulation

6 Liner paper

8 Fabric Material

10 Liner adhesive

12 Seam allowance

14 Pattern section

16 Printed image

18 Seam

20 Quilt (finished)

### DETAILED DESCRIPTION

### General Method

The method generally include a computer, a software program to facilitate the process of creating a desired image (e.g. design, pattern or texture), multiple fabric sheets with a rigid liner adhered to the back and a standard consumer desktop printer for printing the desired design onto the multiple sheets in order to make the desired quilt top layer.

### Preferred Method (Pre-Fabricated)

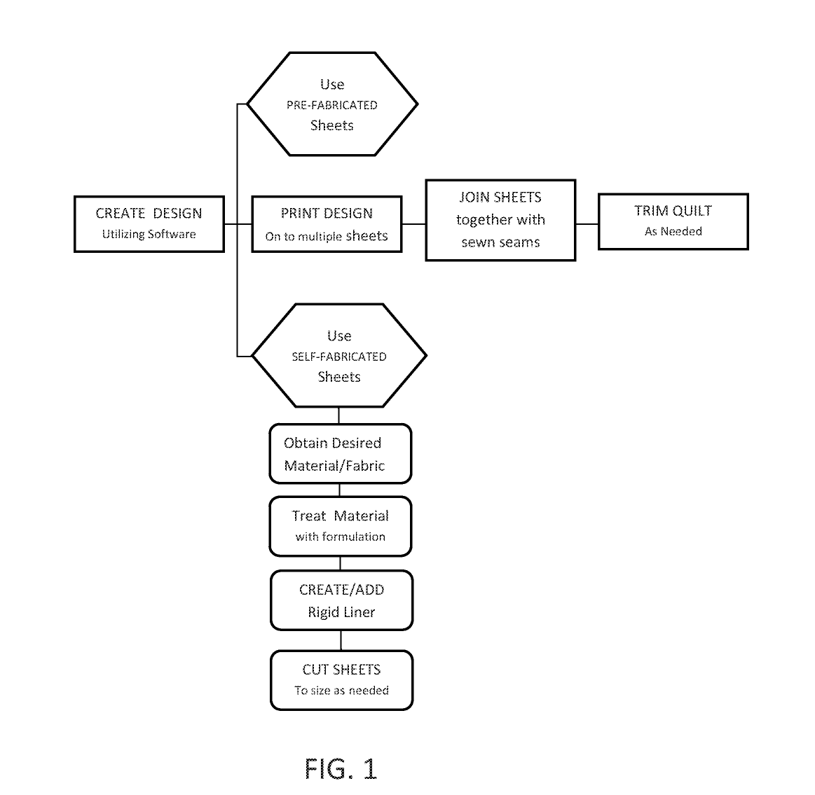

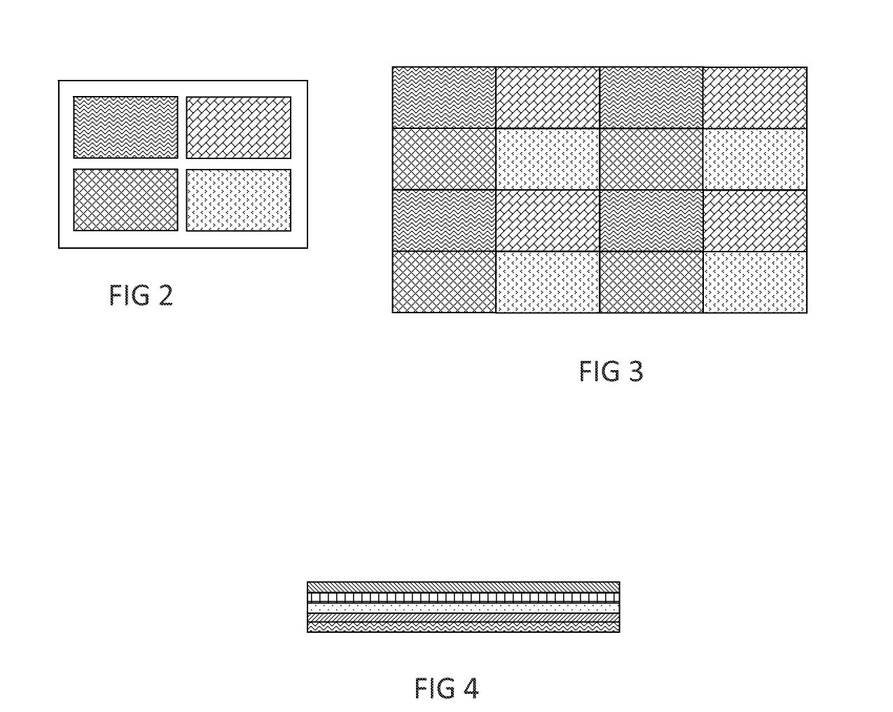

The invention method is graphically illustrated in FIG. 1 through FIG. 8.

### Software Program

A predetermined software program is used to create the desired image 16 for the quilt. The applicant has developed a program which is currently called “FabricNOW” which has proven to be an effective means to facilitate the here described method. The software is currently available to consumers and can be executed on their standard desktop computers.

It should be noted that the quilt 20 is created utilizing patterns and designs that can be customized using the program or for example; by utilizing existing proprietary patterns designs of industry establishments which are legally acquired.

It should also be noted that this method substantially minimizes the amount of fabric 8 or material that is used by the consumer by printing only the amount which is actually needed to make the desired quilt 20. This significantly minimizes waste.

### Fabric Sheets

### Size

Multiple fabric sheets 2 of a common material which are cut to specific sizes that are compatible to enable feeding through a standard consumer printer (e.g. 8½″×11″ or 8½″×18″ or 11″×17″) are provided. The fabric 8 can be made of any desired effective material(s).

### Formulation

The fabric 8 is formulated with a predetermined substance 4 which will enable the ink from the printer to be preserved when the image 16 is printed onto the fabric 8. A substance which is often referred to as a dye/ink fixative and readily available at related fabric and quilting stores has proven to work effectively for this purpose.

### Liner

The sheets 2 have a substantially rigid liner 6 adhered to the back of the fabric 8 to enable the consumer to effectively feed the fabric 8 through the printer. The liner 6 prevents the fabric 8 from being too loose or flimsy so as to get stuck or not feed through the printer properly. It is preferred that this liner 6 is made of a type of paper. Such paper is readily available from traditional paper supply sources.

### Adhesive

The adhesive on the liner 10 is of a predetermined formulation so as to leave little o no residue on the fabric 8 once the liner 6 is removed from the fabric 8.

### Thickness

The combined liner 6 and fabric 8 is of a predetermined overall thickness so that they are not too thick or too thin to feed effectively through the printer as needed.

### Printer

A standard consumer desktop type printer is used for printing the image 16 (design) directly onto the fabric 8. Such printers are readily available to consumers at various stores and outlets, It should be noted that using a commercial grade printer is not prohibitive.

### Post-Print Assembly

Once the desired sheets 2 are printed to enable consumer to make the desired quilt 20, the various sheets 2 are strategically positioned, sewn together with seams 18 by utilizing the seam allowances 12 enabled by the software program when creating the images 16 (patterns/designs) on the multiple sheets 2. The quilt 20 can then be trimmed as/if needed.

### Alternate Method (Self-Fabricated)

The above preferred method can be modified as follows: The fabric sheets 2 can be created by the consumer obtaining a larger size fabric sheet(s) and methodically applying a formulation 4 having the same characteristics described as prefabricated above that enables the fabric 8 to preserve the printing of an image 16 thereon. Once the cut fabric 8 is thoroughly covered with the formulation 4 as needed, a large adhesive backed liner(s) 6 having the same characteristics described as prefabricated above can be applied to the fabric 8. The larger size fabric 8 can then be cut down to multiple smaller sheets sizes having the same characteristics described as prefabricated above. Individual liner(s) 6 could also be added to fabric 8 after fabric 8 is cut into individual sheets.

It should be noted that it may be more economical for the consumer to use the alternate (self-fabricated) method described rather than the preferred pre-fabricated method described due to economy of scale as it relates to the cost of all relevant fabric/materials 8 and components.

While the above description contains much specificity, they should not be construed as limitations on the scope of the invention, but rather as exemplifications of a few basic preferred and alternate methods thereof. Many other possible variations are obvious to individuals skilled in the art.

For example:

The specific, brands and products or the like can be substituted for other similar brands, products or the like which are compatible to work effectively for the method to achieve the desired results.

The specific dimensions and components described can be altered and yet achieve the desired results as described.

The instructions or steps described can be performed to varying degree and/or in varying, order, sequence or combination to achieve the desired end results described.

The method could be used for creating the bottom layer if a pattern on the back of the quilt was desired.

Thus the scope of the invention should be determined by the appended claims and their legal equivalents, rather than by the methods described and illustrated.

I claim:

1. A print-on-demand method for at least one person to create at least the top layer of at least one quilt or the like, which method comprises:
(a) said person utilizing at least one software program to create at least one desired image wherein said image can be printed using at least one standard size personal consumer printer;
(b) said person utilizing multiple sheets of at least one sheeted printable material to print said desired image, wherein said material has a predetermined formulation to receive and substantially preserve said print;
(c) said person printing said image directly onto said multiple sheets, thereby allowing for the minimum amount of material needed to be used;
(d) said person strategically positioning, attaching and trimming said multiple sheets as needed to form said quilt.

2. The method of claim 1, wherein said material is pre-treated to have said predetermined formulation prior to said person acquiring said material.

3. The method of claim 1, wherein said material is treated with a predetermined said formulation after said material is acquired by said person.

4. The method of claim 1, wherein said material is treated with a predetermined said formulation by said person after said material is acquired by said person.

5. The method of claim 1 wherein said printable material is at least one predetermined fabric having at least one substantially rigid removable liner with a substantially adhesive material to enable said liner to adhere onto said fabric; thereby enabling said sheet to be fed through said printer for printing of said image.

6. The method of claim 1 wherein said printable material is at least one predetermined fabric having at least one substantially rigid removable liner with a substantially adhesive material to enable said liner to adhere onto said fabric; thereby enabling said sheet to be effectively fed through said printer for printing of said image, wherein said liner is adhered to said fabric before said fabric is acquired by said person.

7. The method of claim 1 wherein said printable material is at least one predetermined fabric having at least one substantially rigid removable liner with a substantially adhesive material to enable said liner to adhere onto said fabric; thereby enabling said sheet to be effectively fed through said printer for printing of said image, wherein said liner is adhered to said fabric after said fabric is acquired by said person.

8. The method of claim 1 wherein said printable material is at least one predetermined fabric having at least one substantially rigid removable liner with a substantially adhesive material to enable said liner to adhere onto said fabric; thereby enabling said sheet to be effectively fed through said printer for printing of said image, wherein said liner is adhered to said fabric by said person after said fabric is acquired by said person.

9. The method of claim 5 wherein said adhesive is formulated to leave at most unsubstantial and minimal residue on said fabric.

10. The method of claim 1 wherein said images are predetermined

11. The method of claim 10 wherein said predetermined images are designs which are legally acquired and proprietary to certain industry establishments.

12. The method of claim 10 wherein said predetermined images are retired designs or patterns.

13. The method of claim 1 wherein said image consist of multiple pattern sections thereby enabling more efficient and simple creation of at least one quilt having at least one image having a plurality of patterns.

14. The method of claim 13 wherein said pattern sections are strategically positioned and stitching is strategically placed in between at least one of said pattern sections thereby creating at least one seam which substantially simulates the joining of separate patterns sections common to the appearance of a traditional quilt.

15. A print-on-demand method for at least one person to create at least the top layer of at least one quilt or the like, which method comprises:
(a) said person utilizing at least one software program to create at least one desired image wherein said image can be printed using at least one standard size personal consumer printer;
(b) said person utilizing multiple sheets of at least one sheeted printable fabric having at least one removable adhesive backed substantially rigid liner to print said desired image, wherein said fabric has a predetermined formulation to receive and substantially preserve said print;
(c) said person printing said image directly onto said multiple sheets, thereby allowing for the minimum amount of material needed to be used;
(d) said person strategically positioning, attaching and trimming said multiple sheets as needed to form said quilt.
